(19) United States
(12) Patent Application Publication
(10) Pub. No.: US 2025/0061342 A1
(43) Pub. Date: Feb. 20, 2025

(54) NOVEL PROCEDURE BETWEEN SERVER AND DISTRIBUTED CLIENTS FOR AI/ML FEDERATED LEARNING

(71) Applicant: TENCENT AMERICA LLC, Palo Alto, CA (US)

(72) Inventor: Iraj SODAGAR, Palo Alto, CA (US)

(73) Assignee: TENCENT AMERICA LLC, Palo Alto, CA (US)

(21) Appl. No.: 18/805,020

(22) Filed: Aug. 14, 2024

Related U.S. Application Data
(60) Provisional application No. 63/532,855, filed on Aug. 15, 2023.

(51) Int. Cl. G06N 3/098

(52) U.S. Cl. CPC G06N 3/098

(57) ABSTRACT

According to an aspect of the disclosure, an apparatus, and similarly a method and computer readable medium for distributed learning in a 5GMS network are provided. The method may include: triggering, by a 5GMS network device, a federated learning session between a user device and the 5GMS network device; selecting, by the 5GMS network device, a partially trained AI model in the 5GMS network; broadcasting, by the 5GMS network device to the user device, eligibility criteria for user devices to participate in federated learning in the 5GMS network; broadcasting, by the 5GMS network device to the user device, failure reporting criteria for the user devices; and transmitting, by the 5GMS network device and to the user device, the partially trained AI model.

### CROSS-REFERENCE TO RELATED APPLICATION

This application claims priority to U.S. provisional application 63/532,855, filed on Aug. 15, 2023, the disclosure of which is incorporated herein by reference in its entirety.

### TECHNICAL FIELD

This disclosure relates to AI/ML federated learning, and in particular relates to procedures in which server and distributed devices with AI/ML capability perform federated learning in a 5G network.

### BACKGROUND

In federated learning, each device uses its local data and possibly part of the server-provided data to improve its AI/ML model and then communicate its improvements to servers and consequently to the other devices.

Artificial intelligence (AI) and machine learning (ML) have been advanced in recent years and found many applications. The application of AI/ML in 5G networks is a new topic. Recently the 3GPP SA4 started a study item on AI/ML for media, which will produce a technical report on the subject.

The objectives of SA4's “Artificial Intelligence (AI) and Machine Learning (ML) for Media” are primarily to identify the media service architectures and relevant service flows, model operation configurations, data components including available data formats, and the data traffic The study item results is being maintained in a permanent document (PD).

While the PD includes different collaboration scenarios between networks and devices, including federated learning, it does not discuss the communication between the network and device during federated learning, and therefore, such deficiencies exist in the computer technology.

And for any of those reasons there is therefore a desire for technical solutions to such problems that arose in computer technology.

### SUMMARY

According to an aspect of the disclosure, an apparatus, and similarly a method and computer readable medium for distributed learning in a 5GMS network are provided. The apparatus and/or computer readable medium may include at least one memory configured to store computer program code; and at least one processor configured to access the computer program code and operate as instructed by the computer program code. The computer program code may include code to implement the method. The method may include: triggering, by a 5GMS network device, a federated learning session between a user device and the 5GMS network device; selecting, by the 5GMS network device, a partially trained AI model in the 5GMS network; broadcasting, by the 5GMS network device to the user device, eligibility criteria for user devices to participate in federated learning in the 5GMS network; broadcasting, by the 5GMS network device to the user device, failure reporting criteria for the user devices; and transmitting, by the 5GMS network device and to the user device, the partially trained AI model.

According to an aspect of the disclosure, the method may include transmitting, by the 5GMS network device and to the user device, a request for evaluating the partially trained AI model; and receiving, by the 5GMSN network device and from the user device, one of: evaluation results in response to successfully evaluating the partially trained AI model; or failure results in response to an successfully evaluation of the partially trained AI model by the user device.

According to an aspect of the disclosure, the method may include updating, by the 5GMS network device, the eligibility criteria for the user devices to participate in federated learning in the 5GMS network.

According to an aspect of the disclosure, the eligibility criteria for the user devices to participate in federated learning are updated in response to receiving one or more evaluation results from one or more user devices.

According to an aspect of the disclosure, the method may include transmitting, by the 5GMS network device and to the user device, a request for training the partially trained AI model; and receiving, by the 5GMS network device and from the user device, one of: an updated AI model in response to a training by the user device of the partially trained AI model; evaluation results in response to successfully evaluating the partially trained AI model; or failure results in response to an unsuccessful training of the partially trained AI model by the user device.

According to an aspect of the disclosure, the method may include updating the partially trained AI model by the 5GMS network device by aggregating results from one or more user device.

According to an aspect of the disclosure, the method may include transmitting, by the 5GMS network device to the user device, the updated partially trained AI model.

### BRIEF DESCRIPTION OF THE DRAWINGS

The above and other features and aspects of embodiments of the disclosure will be apparent from the following description taken in conjunction with the accompanying drawings, in which:

FIG. 1 is a simplified diagram of a communication system in accordance with embodiments;

FIG. 2 is a simplified diagram of a streaming environment in accordance with embodiments;

FIG. 3 is a simplified diagram of a functional block diagram of a video decoder in accordance with embodiments;

FIG. 4 is a simplified diagram of a functional block diagram of a video encoder in accordance with embodiments;

FIG. 5 is a simplified diagram of a federated learning architecture in accordance with embodiments;

FIG. 6 is a simplified workflow for distributed/federated learning between a user device and the network in related art;

FIGS. 7A and 7B are simplified workflow diagrams of a procedure between server and distributed clients for AI/ML federated learning; and

FIG. 8 is a simplified diagram in accordance with embodiments.

### DETAILED DESCRIPTION

The following detailed description of example embodiments refers to the accompanying drawings. The same reference numbers in different drawings may identify the same or similar elements.

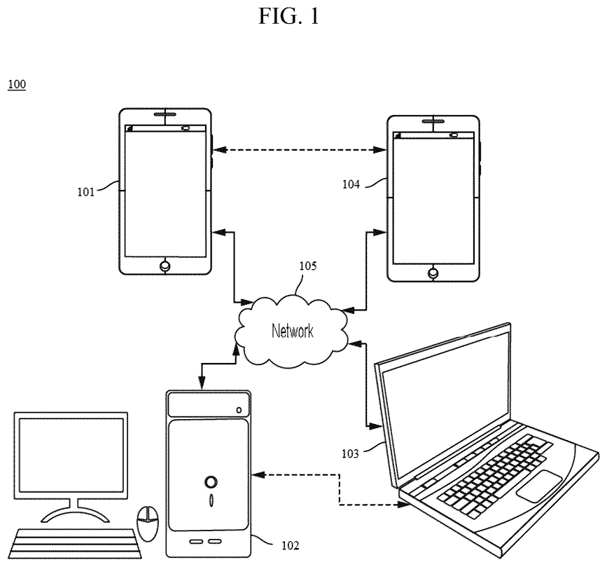

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

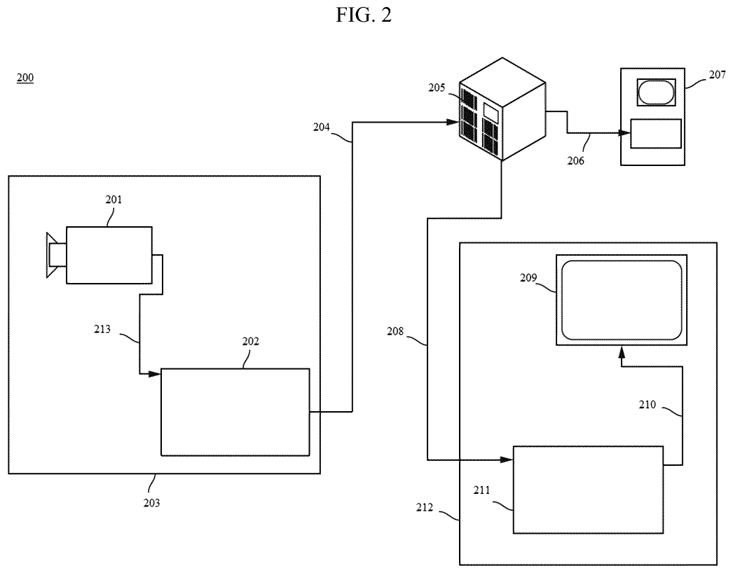

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

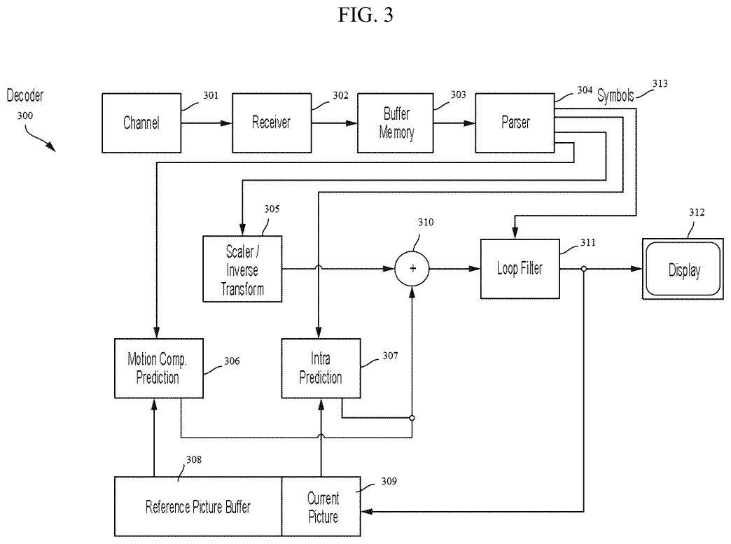

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosynchronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the render device 312 as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

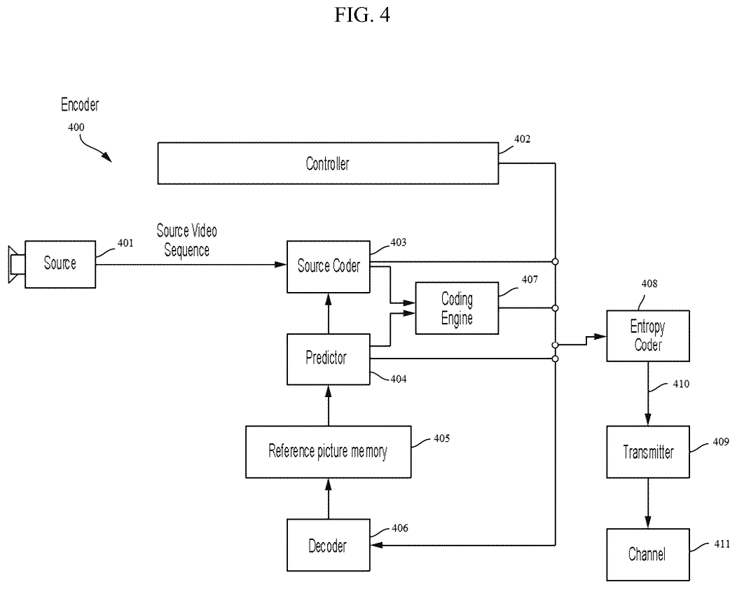

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder 402 (“source coder” henceforth) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture cache 405. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

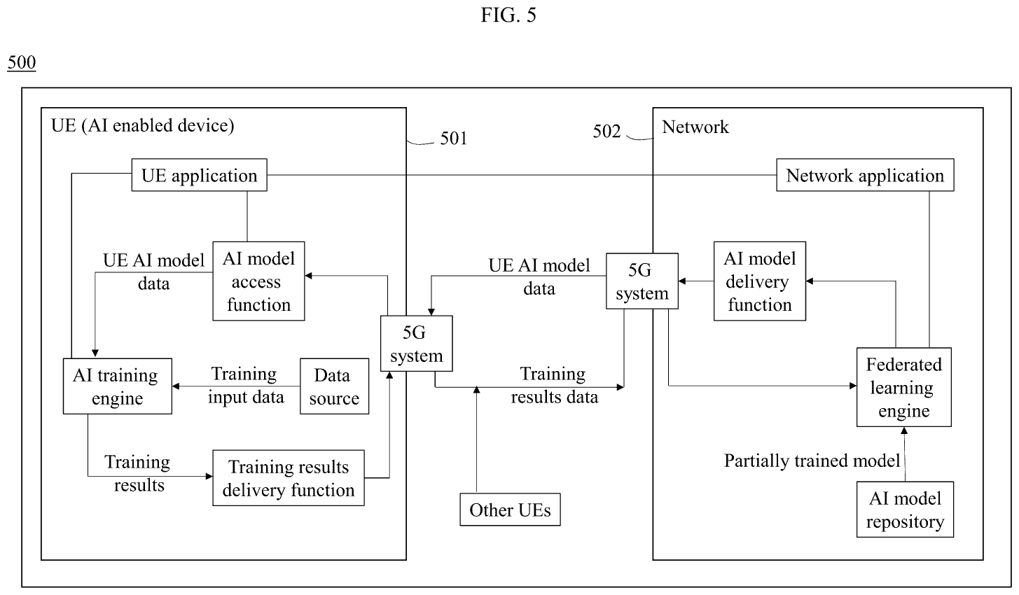

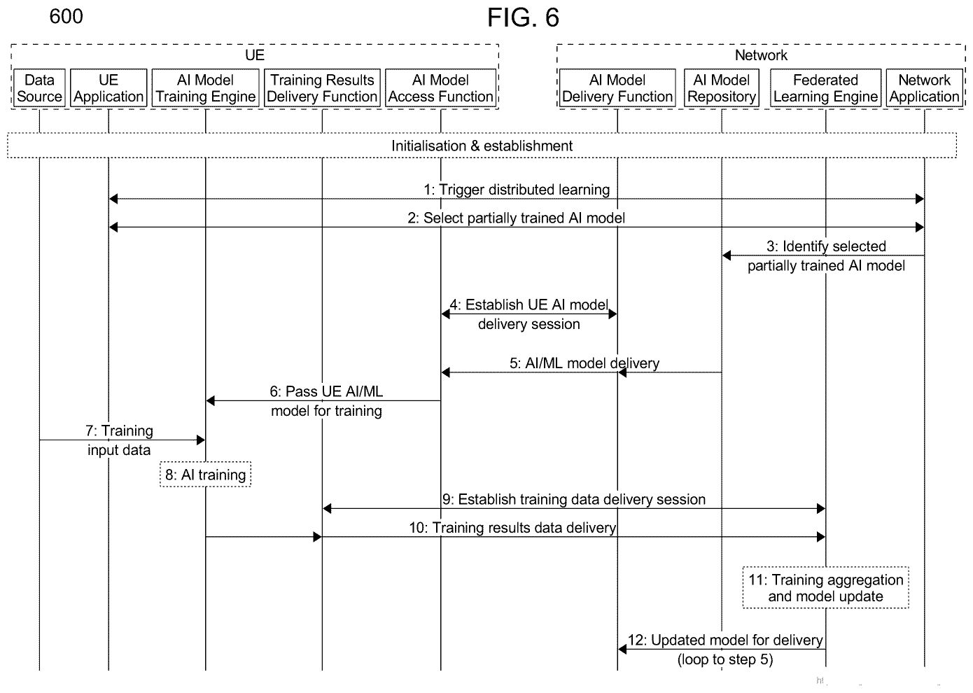

As 3GPP SA4 explores AI/ML for media, a procedure framework for federated learning is provided by embodiments herein. For example, see FIG. 5 showing example 500 as a federated learning architecture according to embodiments herein. FIG. 6 shows an example process 600 implementing a workflow for distributed/federated learning between a user device and the network.

As shown in FIG. 5, the network 502 can provide the AI model to the device 501. This can also be seen in the example 600 of FIG. 6 at step S601. The device 501 can perform local training on the model and provide the results back to the network 501. This can also be seen in the example 600 of FIG. 6 at operations 5 and 10. The network/service can use this training result to update the AI model and optionally provide the updated model to the device and other devices.

Embodiments herein provide for a communication procedure for federated learning between the central service, located on the network 502, and devices, such as device 501, for the federated learning process.

According to embodiments, when a set of devices, such as one of the devices 501, participates in federated learning, any of those devices can send and receive messages to a service server, such as of the network 502.

According to embodiments, the behavior of device eligibility messages is from a network server, such as of network 502, and to a device, such as the device 501. The server sends a model update message to all devices to update the AI/ML model with the new model parameters. The message contains the model id of the AI/ML model to be updated, the updated model parameters that the user device will use to train the model in the next round, and the new model id when the parameters are updated.

After running the training locally, each device may send a model update message to the server with the updated parameters. Together with the received model evaluation message, the server can decide if the global model needs to be updated or not.

According to embodiments, there is also provided a “failure reporting message”. Error messages are used to handle unexpected errors or exceptions that may occur during the training process. For example, the server may send an error message to all devices to handle a device failure or network disruption.

According to embodiments, device eligibility messages from a network server, such as of network 502, and to a device, such as the device 501 may be sent. The server sends a request to all devices to report a device failure or network disruption.

As 3GPP SA4 explores AI/ML for media, a procedure framework for federated learning is provided by embodiments herein. For example, see FIG. 6 showing example 600 as a federated learning architecture according to embodiments herein.

Federated learning may be divided into four components: (1) defining eligibility criteria for participating devices; (2) defining failure reporting criteria; (3) evaluating a model; and (4) updating the model.

Defining eligibility criteria for participating devices: not all devices may be good candidates for participating in AI/ML federated learning, and need to be filtered out accordingly. This stage may define the selected group based on various criteria such as the amount, quality, type, and age of the data, language support, geographical location, the speed of training, and other parameters.

Defining the failure reporting criteria: No every device may be able to perform the requested tasks in the federated learning, and failure criteria need to be understood/defined accordingly. Therefore devices should be able to report their failure depending on the criteria set by the network in a federated learning operation.

Evaluating a model: Every participating device should be able to evaluate a given model with the data it has access to and report the evaluation results to the network.

Updating a model: Every participating device should be able to train/retrain a given model with the data it has access to and report the training results to the network.

In embodiments, the evaluation of the model and the updation of the model may be performed in a synchronized manner by the network announcing the starting time of the step and also informing the expected time to get the results back.

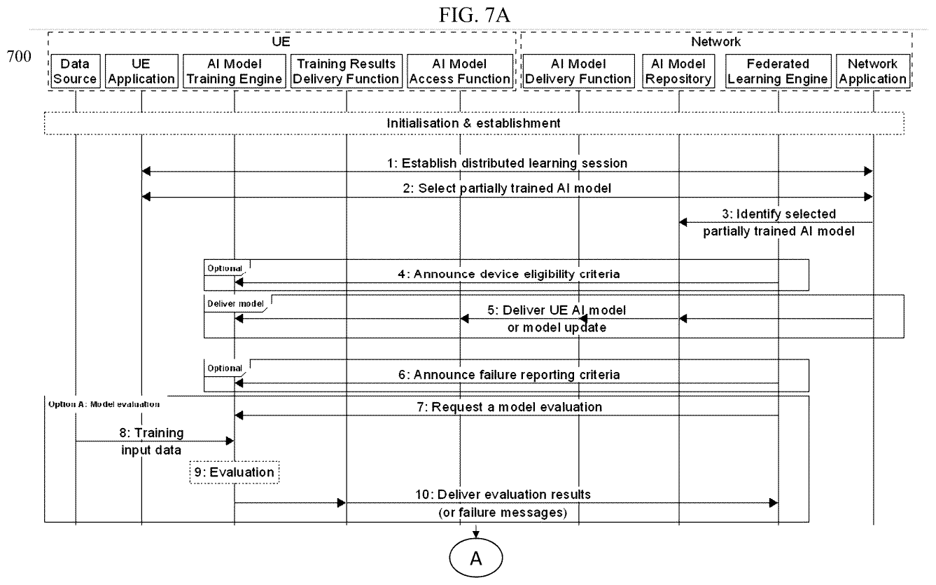

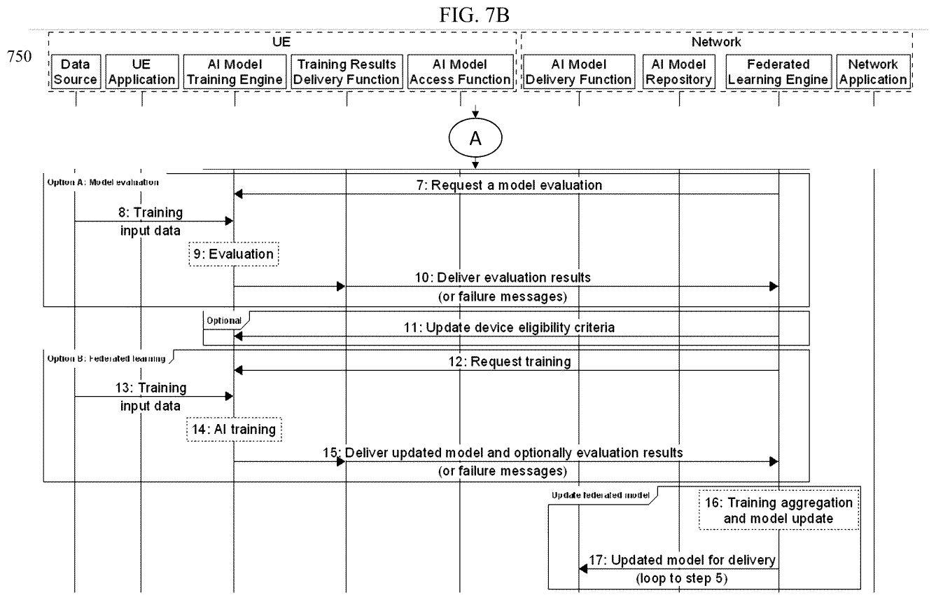

FIG. 7A illustrates process 700 and FIG. 7B illustrate process a process 750 which is a continuation of process 700. Process 700 and 750 illustrate a workflow for distributed AI/ML federated learning between the user device and the network.

During the initialization and establishment operation, information related to the required features and detailed configurations are exchanged and negotiated between the network and user device. Information may include information related to user device and network capabilities, AI/ML service information (e.g. service requirements, AI/ML model descriptions), and delivery methods. Such information may be used for the selection of a suitable partially trained AI/ML model for the service.

At operation 1, the user device, e.g., device 501, a network device, e.g., a device of network 502, communicate to trigger distributed/federated learning, using the information from the initialization and establishment step.

At operation 2, a partially trained AI model may be selected between the user device, e.g., device 501, a network device, e.g., a device of network 502.

At operation 3, a network application on the network device may identify the selected partially trained AI model in the AI model Repository/Provider of the network.

At operation 4, the Federated Learning Engine of the network device may announce the eligibility criteria for participating in the federated evaluation/learning to the device.

At operation 5, the AI Model Access Function of an eligible device receives the partially trained AI model or its updated version from the network device.

At operation 6, the Federated Learning Engine may announce the failure reporting criteria for the participating devices.

### Model Evaluation:

At operation 7, the Federated Learning Engine of the network device requests the user device to start the model evaluation.

At operation 8, the Data Source of the user device may pass the training input data to the AI model Training Engine within the user device.

At operation 9, the AI Model Training Engine may perform the evaluation at the user device.

At operation 10, when the training is successful or completed by the user device, evaluation results, may be delivered to the Federated Learning Engine of the network device. When the training is unsuccessful or incomplete or unable to be completed by the user device, failure messages, may be delivered to the Federated Learning Engine of the network device.

In embodiments, at operation 11, the device eligibility criteria may get updated by the network device to one or more user devices depending on the evaluation results.

### Federated Training:

At operation 12, the Federated Learning Engine may request the user device to start the training.

At operation 13, the Data Source of the user device may pass the training input data to the AI model Training Engine of the user device.

At operation 14, AI Model Training Engine of the user device may retrain the model.

At operation 15, the updated model (or the failure messages, in the case of a failure) may be delivered to the Federated Learning Engine of the network device.

At operation 16, the Federated Learning Engine of the network device may perform training aggregation of training results from multiple UEs and may update the partially trained AI model.

At operation 17, the updated partially trained AI model may be delivered to the user device as from operation 5.

While process 700 and 750 are exemplary, but a person of skill in the art will realize that the operations are not limited to the order explained herein. As an example, a person of skilled in the art will understand that the model evaluation and the federated learning may occur in a sequence or in parallel.

Accordingly, aspects of the disclosure may include performing a set of procedures for defining the device eligibility in participating in a federated learning, wherein the network defines the device failure criteria wherein a device should report its failures, wherein the network can define a collaborative procedure to evaluate a model on various devices and get the evaluation results back from those devices. The network can use those results to redefine the device eligibility for a better more relevant federated training, wherein the network can request the eligible devices to retrain the model, each using their data. In embodiments, the training can be synchronized wherein each device reports the results of its training and the updated model to the network. The network studies the various updated models and results from each device, either the updates the model or do additional training with the data it has and then stores the model in its database, wherein the network can inform all eligible devices with the updated AI/ML model.

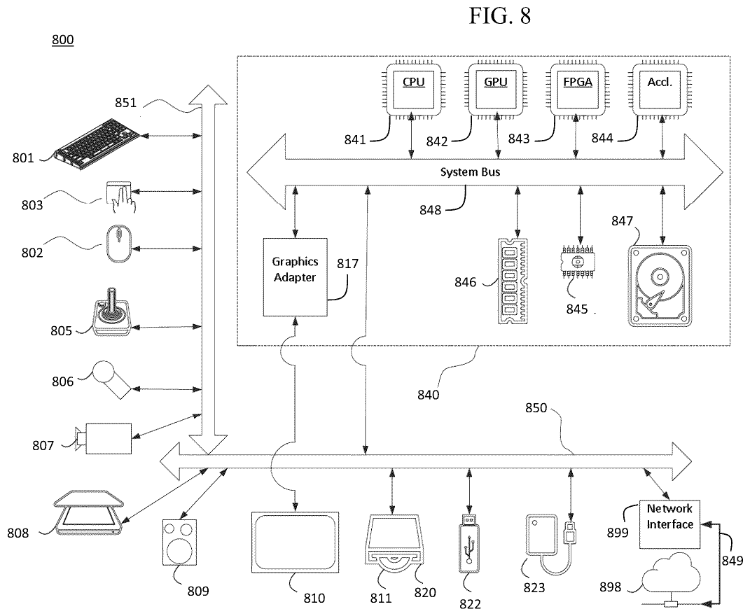

The techniques described above, can be implemented as computer software using computer-readable instructions and physically stored in one or more computer-readable media or by a specifically configured one or more hardware processors. For example, FIG. 8 shows a computer system 800 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system 800 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 800.

Computer system 800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 801, mouse 802, trackpad 803, touch screen 810, joystick 805, microphone 806, scanner 808, camera 807.

Computer system 800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 810, or joystick 805, but there can also be tactile feedback devices that do not serve as input devices), audio output devices (such as: speakers 809, headphones (not depicted)), visual output devices (such as screens 810 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 800 can also include human accessible storage devices and their associated media such as optical media including CD/DVD ROM/RW 820 with CD/DVD 811 or the like media, thumb-drive 822, removable hard drive or solid state drive 823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 800 can also include interface 899 to one or more communication networks 898. Networks 898 can for example be wireless, wireline, optical. Networks 898 can further be local, wide-area, metropolitan, vehicular and industrial, real-time, delay-tolerant, and so on. Examples of networks 898 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 898 commonly require external network interface adapters that attached to certain general-purpose data ports or peripheral buses (850 and 851) (such as, for example USB ports of the computer system 800; others are commonly integrated into the core of the computer system 800 by attachment to a system bus as described below (for example Ethernet interface into a PC computer system or cellular network interface into a smartphone computer system). Using any of these networks 898, computer system 800 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 840 of the computer system 800.

The core 840 can include one or more Central Processing Units (CPU) 841, Graphics Processing Units (GPU) 842, a graphics adapter 817, specialized programmable processing units in the form of Field Programmable Gate Areas (FPGA) 843, hardware accelerators for certain tasks 844, and so forth. These devices, along with Read-only memory (ROM) 845, Random-access memory 846, internal mass storage such as internal non-user accessible hard drives, SSDs, and the like 847, may be connected through a system bus 848. In some computer systems, the system bus 848 can be accessible in the form of one or more physical plugs to enable extensions by additional CPUs, GPU, and the like. The peripheral devices can be attached either directly to the core's system bus 848, or through a peripheral bus 849. Architectures for a peripheral bus include PCI, USB, and the like.

CPUs 841, GPUs 842, FPGAs 843, and accelerators 844 can execute certain instructions that, in combination, can make up the aforementioned computer code. That computer code can be stored in ROM 845 or RAM 846. Transitional data can be also be stored in RAM 846, whereas permanent data can be stored for example, in the internal mass storage 847. Fast storage and retrieval to any of the memory devices can be enabled through the use of cache memory, that can be closely associated with one or more CPU 841, GPU 842, mass storage 847, ROM 845, RAM 846, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 800, and specifically the core 840 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 840 that are of non-transitory nature, such as core-internal mass storage 847 or ROM 845. The software implementing various embodiments of the present disclosure can be stored in such devices and executed by core 840. A computer-readable medium can include one or more memory devices or chips, according to particular needs. The software can cause the core 840 and specifically the processors therein (including CPU, GPU, FPGA, and the like) to execute particular processes or particular parts of particular processes described herein, including defining data structures stored in RAM 846 and modifying such data structures according to the processes defined by the software. In addition or as an alternative, the computer system can provide functionality as a result of logic hardwired or otherwise embodied in a circuit (for example: accelerator 844), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for distributed artificial intelligence/machine learning (AI/ML) federated learning in a 5GMS network, the method being executed by a processor, and the method comprising:
triggering, by a 5GMS network device, a federated learning session between a user device and the 5GMS network device;
selecting, by the 5GMS network device, a partially trained AI model in the 5GMS network;
broadcasting, by the 5GMS network device to the user device, eligibility criteria for user devices to participate in federated learning in the 5GMS network;
broadcasting, by the 5GMS network device to the user device, failure reporting criteria for the user devices; and
transmitting, by the 5GMS network device and to the user device, the partially trained AI model.

2. The method of claim 1, wherein the method further comprises:
transmitting, by the 5GMS network device and to the user device, a request for evaluating the partially trained AI model; and
receiving, by the 5GMSN network device and from the user device, one of:
evaluation results in response to successfully evaluating the partially trained AI model; or
failure results in response to an successfully evaluation of the partially trained AI model by the user device.

3. The method of claim 1, wherein the method further comprises:
updating, by the 5GMS network device, the eligibility criteria for the user devices to participate in federated learning in the 5GMS network.

4. The method of claim 3, wherein the eligibility criteria for the user devices to participate in federated learning are updated in response to receiving one or more evaluation results from one or more user devices.

5. The method of claim 1, wherein the method further comprises:
transmitting, by the 5GMS network device and to the user device, a request for training the partially trained AI model; and
receiving, by the 5GMS network device and from the user device, one of:
an updated AI model in response to a training by the user device of the partially trained AI model;
evaluation results in response to successfully evaluating the partially trained AI model; or
failure results in response to an unsuccessful training of the partially trained AI model by the user device.

6. The method of claim 5, further comprising:
updating the partially trained AI model by the 5GMS network device by aggregating results from one or more user device.

7. The method of claim 6, further comprising:
transmitting, by the 5GMS network device to the user device, the updated partially trained AI model.

8. An apparatus comprising:
at least one memory configured to store computer program code;
at least one processor configured to access the computer program code and operate as instructed by the computer program code, the computer program code comprising:
triggering code configured to cause the at least one processor to trigger a federated learning session between a user device and a 5GMS network device;
selecting code configured to cause the at least one processor to select, by the 5GMS network device, a partially trained AI model in the 5GMS network;
first broadcasting code configured to cause the at least one processor to broadcast, by the 5GMS network device to the user device, eligibility criteria for user devices to participate in federated learning in the 5GMS network;
second broadcasting code configured to cause the at least one processor to broadcast, by the 5GMS network device to the user device, failure reporting criteria for the user devices; and
first transmitting code configured to cause the at least one processor to transmit, by the 5GMS network device and to the user device, the partially trained AI model.

9. The apparatus according to claim 8, wherein the program code further comprises:
second transmitting code configured to cause the at least one processor to transmit, by the 5GMS network device and to the user device, a request for evaluating the partially trained AI model; and
first receiving code configured to cause the at least one processor to receive, by the 5GMSN network device and from the user device, one of:
evaluation results in response to successfully evaluating the partially trained AI model; or
failure results in response to an successfully evaluation of the partially trained AI model by the user device.

10. The apparatus according to claim 8, wherein the program code further comprises:
first updating code configured to cause the at least one processor to update, by the 5GMS network device, the eligibility criteria for the user devices to participate in federated learning in the 5GMS network.

11. The apparatus according to claim 10, wherein the eligibility criteria for the user devices to participate in federated learning are updated in response to receiving one or more evaluation results from one or more user devices.

12. The apparatus according to claim 8, wherein the program code further comprises:
third transmitting code configured to cause the at least one processor to transmit, by the 5GMS network device and to the user device, a request for training the partially trained AI model; and
second receiving code configured to cause the at least one processor to receive, by the 5GMS network device and from the user device, one of:
an updated AI model in response to a training by the user device of the partially trained AI model;
evaluation results in response to successfully evaluating the partially trained AI model; or
failure results in response to an unsuccessful training of the partially trained AI model by the user device.

13. The apparatus according to claim 12, wherein the program code further comprises:
second updating code configured to cause the at least one processor to update the partially trained AI model by the 5GMS network device by aggregating results from one or more user device.

14. The apparatus according to claim 13, wherein the program code further comprises:
fourth transmitting code configured to cause the at least one processor to transmit, by the 5GMS network device to the user device, the updated partially trained AI model.

15. A non-transitory computer readable medium storing a program causing a processor to:
trigger, by a 5GMS network device, a federated learning session between a user device and the 5GMS network device;
select, by the 5GMS network device, a partially trained AI model in the 5GMS network;
broadcast, by the 5GMS network device to the user device, eligibility criteria for user devices to participate in federated learning in the 5GMS network;
broadcast, by the 5GMS network device to the user device, failure reporting criteria for the user devices; and
transmit, by the 5GMS network device and to the user device, the partially trained AI model.

16. The non-transitory computer readable medium of claim 15, wherein the program code further causes the processor to:
transmit, by the 5GMS network device and to the user device, a request for evaluating the partially trained AI model; and
receive, by the 5GMSN network device and from the user device, one of:
evaluation results in response to successfully evaluating the partially trained AI model; or
failure results in response to an successfully evaluation of the partially trained AI model by the user device.

17. The non-transitory computer readable medium of claim 15, wherein the program code further causes the processor to:
update, by the 5GMS network device, the eligibility criteria for the user devices to participate in federated learning in the 5GMS network.

18. The non-transitory computer readable medium of claim 17, wherein the eligibility criteria for the user devices to participate in federated learning are updated in response to receiving one or more evaluation results from one or more user devices.

19. The non-transitory computer readable medium of claim 15, wherein the program code further causes the processor to:
transmit, by the 5GMS network device and to the user device, a request for training the partially trained AI model; and
receive, by the 5GMS network device and from the user device, one of:
an updated AI model in response to a training by the user device of the partially trained AI model;
evaluation results in response to successfully evaluating the partially trained AI model; or
failure results in response to an unsuccessful training of the partially trained AI model by the user device.

20. The non-transitory computer readable medium of claim 20, wherein the program code further causes the processor to:
update the partially trained AI model by the 5GMS network device by aggregating results from one or more user device.
